(19) United States
(12) Patent Application Publication
(10) Pub. No.: US 2006/0244179 A1
(43) Pub. Date: Nov. 2, 2006

(54) METHOD FOR MANUFACTURING A FIBER-REINFORCED SYNTHETIC PART

(75) Inventor: Peter Denk, Freiburg (DE)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignee: DENK Engineering GmbH, Freiburg (DE)

(21) Appl. No.: 11/380,723

(22) Filed: Apr. 28, 2006

(30) Foreign Application Priority Data
Apr. 30, 2005 (DE) 102005020274.8-16

(51) Int. Cl. B29C 70/30

(52) U.S. Cl. 264/257

(57) ABSTRACT

A procedure for producing a fiber-reinforced manufactured part.

### CROSS REFERENCE TO RELATED APPLICATION

This application claims priority to German patent application 10 2005 020 274.8-16 which was filed on Apr. 30, 2005.

### BACKGROUND

This invention deals with a method for producing a fiber-reinforced manufactured (a.k.a., synthetic) part in which a fiber laminate is positioned onto a flexible interior part, after which the interior part is coated with a fiber laminate and positioned into a female form and the interior part is expanded.

Such manufactured parts are used in a multiplicity of applications, for example bicycle frames or other branching tubular structures, bins, a profile shrink boot, etc.

Some of these applications necessitate as even a surface as possible. This can only be achieved by the use of a female form in its production. In one production method, an inner layer is used that is coated with fiber-reinforced manufactured material and pressed into a female form whereby wrinkles can be formed by the compression that impair the solidity of the manufactured part.

One is also already familiar with the hose blow molding method, in which a flexible hose is coated with fiber-reinforced manufactured material introduced into a female form and the hose is inflated or expanded under impact pressure, so that the fiber-reinforced manufactured material is applied against the interior contour of the female form. This is disadvantageous since, once coated with the fiber laminate, the hose displays a form that is highly deviant from that of the part that is to be produced and, as the case may be, wrinkles and unevenness so that, upon expanding the hose, wrinkle formation can occur in the fiber laminate or shifting or inexact positioning of the orientation or changes in the angles of the individual situations which negatively influence the solidity and material properties and, consequently, the over-all quality of the manufactured part.

From DE 40 39 231 A1, a method for producing tubular components from fiber-reinforced manufactured material is known in which the fiber laminate is introduced into an interior shrink boot that has been inflated under pressure, so that it presents a certain stiffness and has the interior form of the component that is to be produced. In the interior shrink boot that is coated with fiber laminate, the pressure is reduced so that it shrinks somewhat and can be introduced into a prefabricated form. With renewed pressure, the fiber laminate is pressed into the prefabricated form to form the shrink boot and, after curing, the shrink boot can be removed from the prefabricated form.

Since the interior shrink book must be elastic to be inflated, then, despite the shaping, precise introduction of the fiber laminate without distorting the interior shrink boot is not possible. Alternatively, the interior pressure in the interior shrink boot would have to be so great that the interior shrink boot would buckle outward beyond the desired design. Moreover, the fiber laminate would be distorted in an undefined manner by the reduction in pressure and constriction of the interior shrink boot, being pinched, for example, at unfavorable spots, so in this method, too, the wrinkle formation is also possible that decreases the quality of the shrink boot that is to be produced.

There is therefore the task of creating a method of the type mentioned at the outset that makes the production of a high-grade manufactured part possible in which wrinkle formation in particular is avoided and with which an exact positioning and angular alignment of the individual fiber layers is guaranteed.

### BRIEF DESCRIPTION OF THE DRAWINGS

The method accorded by the invention is expounded in more detail below on the basis of the drawings, that show:

FIGS. 1 through 10: a complete procedural sequence on the basis of cross-section representations,

FIGS. 11 through 13: individual procedural steps of a modified procedure vs. that in FIGS. 1 through 10,

FIG. 14: a cutaway representation of a prefabricated form with opening channels,

FIGS. 15 through 21: a procedural sequence on the basis of perspective views,

FIGS. 22 through 27: another procedural sequence on the basis of perspective views, and

FIG. 28: a perspective view of a workpiece in a partial sectional.

### DETAILED DESCRIPTION OF THE PREFERRED EMBODIMENTS

The solution for this task, as conferred by the invention, consists in having a manufactured part's interior core coated with flexible material for construction of an at least largely air and/or water tight inner layer sheathing which forms the interior of the manufactured part which, in the course of forming the manufactured that is to be produced, is at least largely fitted to, but preferably proportionately smaller dimensioned than, the manufactured that is to be produced, that the inner layer sheathing is covered with fiber-reinforced material, that the inner layer sheathing with its fiber-reinforced material is introduced into a prefabricated form, and that the inner layer sheathing is expanded in the formation of the fiber-reinforced material to the manufactured part that is to be produced and that the fiber-reinforced material is thereby pressed by pressure onto the interior wall of the prefabricated form serving as a female form during the curing.

With the aid of the manufactured part inner core, the fiber-reinforced material or fiber laminate can be wrinkle free and precisely positioned with a firm application force and introduced onto the adjusted inner layer sheathing of the form of the manufactured part that is to be produced without changing the form of the inner layer sheathing that is to function as an interior manufactured part. Consequently, when expanding the interior manufactured part, the fiber laminate will be evenly expanded to all positions. Since the interior manufactured part only expands after introduction of the fiber laminate, before, however, it becomes reduced and is not or only negligibly flexible, wrinkle formation in the fiber laminate, in the so-called Prepreg, is impossible, so that the fiber-reinforced material can be applied precisely against the interior contour of the prefabricated form when expanding the interior manufactured part and the finished manufactured part displays a proportionate, largely wrinkle-free structure with precisely positioned articulations and, as a result, a higher solidity is achieved.

As fiber material, carbon fiber, graphite fiber, boron fiber, fiberglass or aramid fiber material can, for example, be used.

Latex or silicon can be used in particular for the inner layer sheathing, since these materials are air and water tight, flexible and nevertheless robust.

Foamable manufactured material, gypsum or wax can, for example, be used as material for the manufactured part inner core.

Typically, after the fiber-reinforced material cures, the manufactured part is taken out of the prefabricated form. There are, however, also conceivable applications in which the prefabricated form remains completely or partially on the manufactured part to, for example, reinforce the manufactured part at its end points. Metal parts or pre-cured fiber-reinforced parts can also be introduced into the prefabricated form which, after the fiber-reinforced material cures, are solidly interconnected with the manufactured part and additionally reinforce it.

The inner layer sheathing can be expanded by the introduction of gas or liquid into an interior cavity of the inner layer sheathing. A source of pressurized gas or liquid is connected with a connection area of the inner layer sheathing and gas or liquid is introduced into the interior cavity under pressure. This inevitably leads to the fact that the finished manufactured part has at least one opening in its interior cavity at the junction of the inner layer sheathing. With many manufactured parts, such an opening is not disruptive or even necessary and, if need be, can be closed.

If, however, manufactured parts with a completely closed surface are required, then the interior manufactured part must be completely covered with fiber laminate so that no exterior interface is realizable. To produce this kind of manufactured part, the inner layer sheathing can be expanded by producing a depression on the prefabricated form. For this, opening channels can be introduced into the prefabricated form by which the interior of the prefabricated form is evacuated and thereby a vacuum or negative pressure is generated. The air tight inner layer sheathing will thereby be expanded and the fiber laminate will be pressed onto the inner wall of the prefabricated form. The finished manufactured part displays a completely closed surface.

Since, with this manner of production, the manufactured part inner core remains in the finished manufactured part, it can, according to the operational area of the manufactured part, be advantageous to use an especially facile material, for example foamed manufactured material, for the manufactured part's core.

With manufactured parts that are to be produced which display an interior area opening, the manufactured part's core can be removed from the inner layer sheathing before introduction of the inner layer sheathing equipped with fiber-reinforced material into the prefabricated form. The fiber material already has a certain solidity of its own, so that the inner layer sheathing lets itself be introduced into the prefabricated form with the formally stable fiber prepregs.

It is, however, also possible that, after curing and removing the manufactured part from the prefabricated form, at least the manufactured part inner core is at least partially removed from the manufactured part.

The manner for removing the manufactured part core depends on the material of the manufactured part's inner core. A manufactured part's inner core that is made out of foamed manufactured material can, for example, be rinsed with solvent. A manufactured part's inner core out of gypsum can be shredded by mechanical impinging. Especially in the course of complex molding processes for the manufactured part, hard to access parts of the manufactured part's core can also remain in the manufactured part.

During or after removal of the manufactured part's inner core, even the inner layer sheathing can be at least partially removed from the manufactured part.

The inner layer sheathing can, if need be, also remain completely or partially in the finished manufactured part if, for example, upon removing the inner layer sheathing this breaks and its remains are no longer accessible.

In order to equip the manufactured part's inner core with a complete and accurately shaped inner layer sheathing, it is advisable, if, in forming the inner layer sheathing which is at least largely air and/or water tight, the manufactured part's core is immersed in liquid material or sprayed with this material, or painted, or, as the case may be, impacted, said material attaching to the manufactured part's inner layer and flexibly hardening after being immersed or undergoing some similar impact process.

The manufactured part's inner layer can present a form appendix that forms a connection sleeve for a source of pressurized gas or liquid when coating it with the inner layer material by which pressure can be brought into the interior of the inner layer sheathing and it can thereby be expanded.

It is, however, also possible that a connecting piece may be installed on the inner layer sheathing for a source of pressurized gas or liquid. According to the material of the inner layer sheathing and of the separate connecting piece, which preferably consists of the same material as the inner layer sheathing, the connection can occur by adhesion, fusing, welding or similar methods of connection.

The manufactured part's inner layer can be produced by filling an inner form with the prevailing core material. The inner form can, for example, be produced by milling.

Particularly in the case of complex or very large inner layers of manufactured parts it can be useful if the manufactured part's inner layer is composed of several partial inner cores. Preferably a plurality of cores are assembled from parts and subsequently coated with the inner layer. By this a very complex core is or can be formed, while nevertheless achieving an integral core that can be expanded.

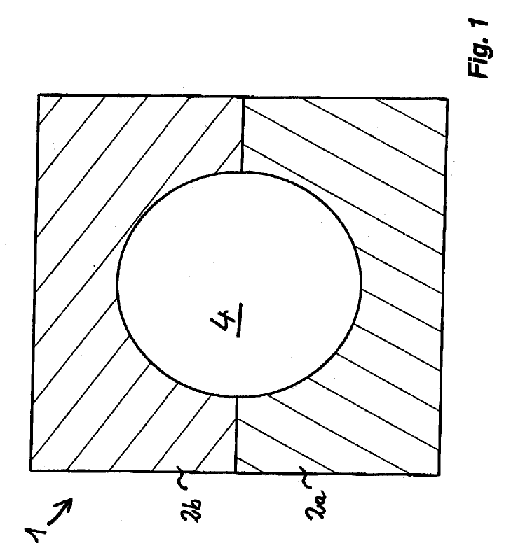

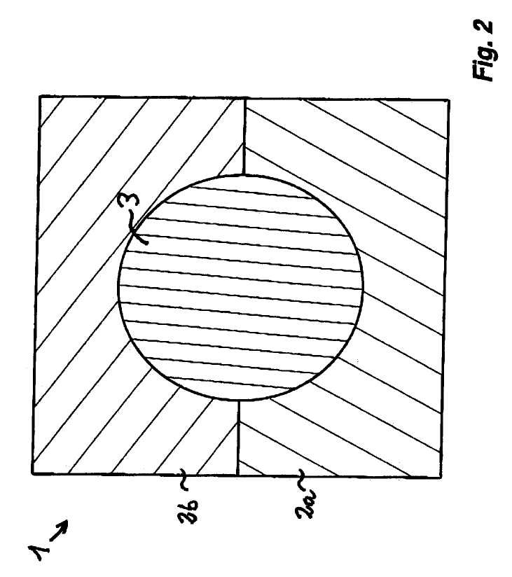

FIG. 1 shows a core form (1) with two core form halves (2a, 2b) for producing a manufactured part inner core (3): FIG. 2 shows the interior cavity (4) of the core form (1) essentially shows the molding sequence of the manufactured part that is to be produced, but is, however, proportionally smaller than the manufactured part. Consequently, the finished manufactured part's inner core (3) has the molding sequence of the manufactured part that is to be produced, but is, however, somewhat smaller in contrast.

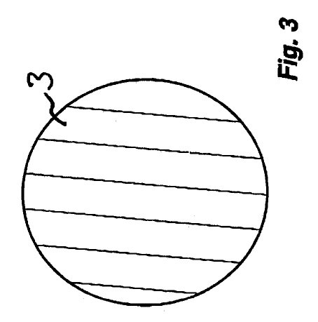

The manufactured part's inner core (3) can, for example, consist of foamed plastic, gypsum or wax that is to be introduced into the closed core form (1). After the curing of the manufactured part's inner core (3), the two core form halves (2a, 2b) are opened and the finished manufactured part's inner core (3) is taken out of the core form (1): FIG. 3.

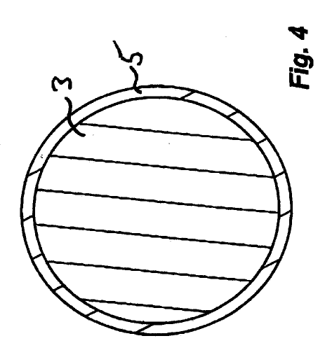

The manufactured part's inner core (3) is subsequently coated with a coating of flexible material, for example silicon or latex, for the formation of an at least largely air and/or water tight inner layer sheathing (5): FIG. 4. For this, the manufactured part's inner core (3) can, for example, be immersed in liquid material that sticks to the manufactured part's inner core (3) and hardens after the immersion process, at the same time remaining flexible however.

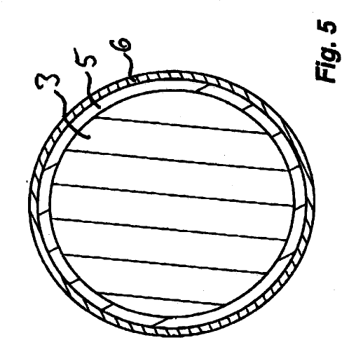

The inner layer sheathing (5) is again covered with fiber-reinforced material (6): FIG. 5. This can take place in such a way that fiber material is first introduced onto the inner layer sheathing (5), that is then brushed with resin. Alternatively, fiber material that is already soaked with resin can be introduced onto the inner layer sheathing (5). The fiber-reinforced material (6) (fiber laminate, Prepreg) will thus be at least largely interlocklingly introduced onto the inner layer sheathing (5) in order to avoid later wrinkle formation.

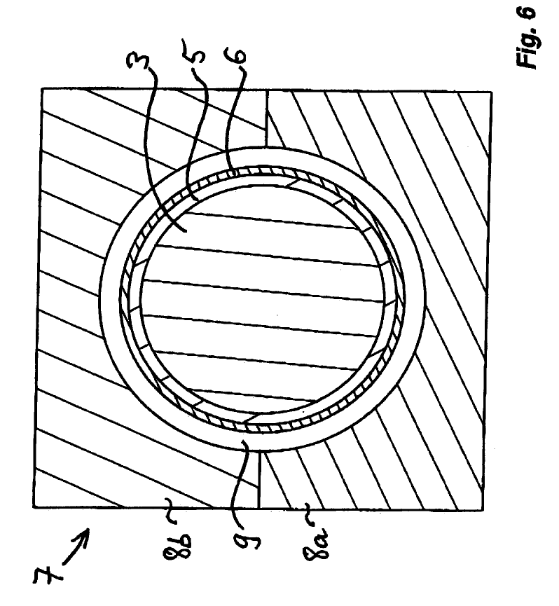

The manufactured part's inner core (3) with its inner layer sheathing (5) and the fiber-reinforced material (6) is introduced into a prefabricated form (7) in accordance with FIG. 6. The prefabricated form is composed of two prefabricated form halves (8a and 8b) which define an interior cavity (9), which is the female form of the manufactured part that is to be produced. As becomes clear from FIG. 6, the interior cavity (9) of the prefabricated form (7) is equivalently larger than the workpiece from the manufactured part's inner core (3), inner layer sheathing (5) and fiber-reinforced material (6), so that when closing the prefabricated form halves (8a and 8b) no fibers of the workpiece can be wedged in which could otherwise lead to wrinkle formation.

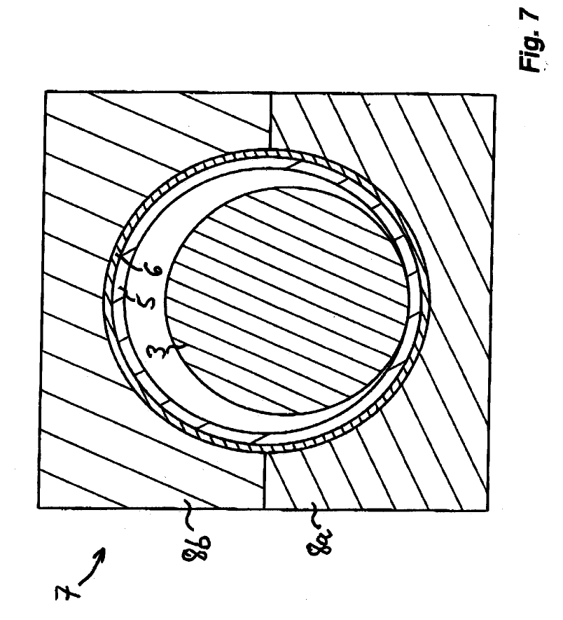

After inserting the workpiece into the prefabricated form (7), the inner layer sheathing (5) is expanded: FIG. 7, as gas or liquid is introduced into the inner layer sheathing (5) under pressure. With the expansion of the inner layer sheathing (5), the layer installation of the fiber-reinforced material (6) is expanded and pressed onto the inner wall of the prefabricated form (7), whereby the fiber-reinforced material (6) assumes the form and size of the manufactured part that is to be produced. The pressure can be maintained until at least a partial curing of the fiber-reinforced material (6), in order to avoid backformation. Thereby, the prefabricated form (7) can, if need be, at least be heated at times in order to accelerate the curing process or, according to the type of materials that are used, to start right off.

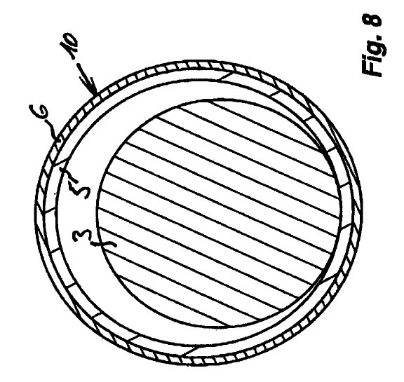

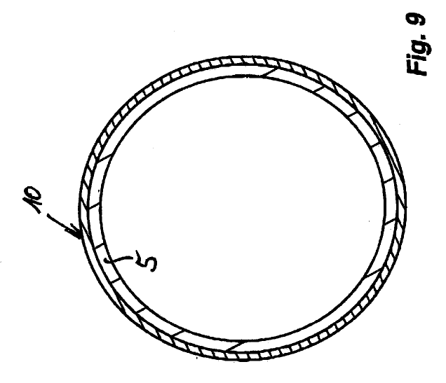

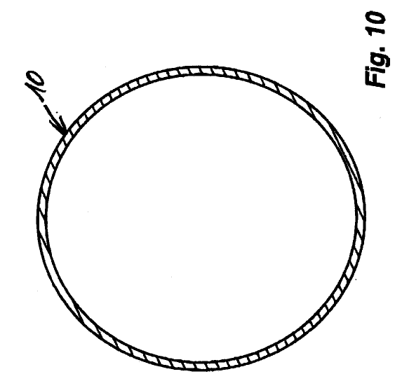

After curing, the workpiece is taken out of the prefabricated form (7): FIG. 8. The fiber-reinforced material (6) is now shaped into the manufactured part that is to be produced. The manufactured part's inner core (3), as well as the expanded inner layer sheathing (5), are still in its interior. According to their subsequent application, these can remain in the manufactured part (10). It is preferable, however, if the manufactured part's interior component (3), or inner core, is removed: FIG. 9. According to the material of the manufactured part's inner core (3), this can take place by rinsing, melting or cracking, crumbling or a similar atomization process. Subsequently, the expanded inner layer sheathing (5) is removed from the manufactured part (10): FIG. 10.

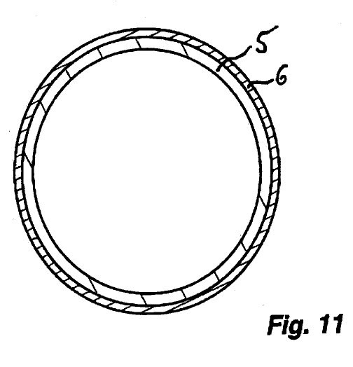

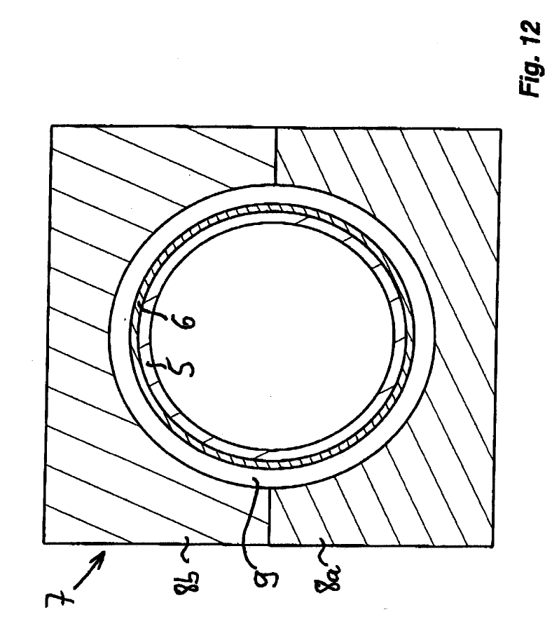

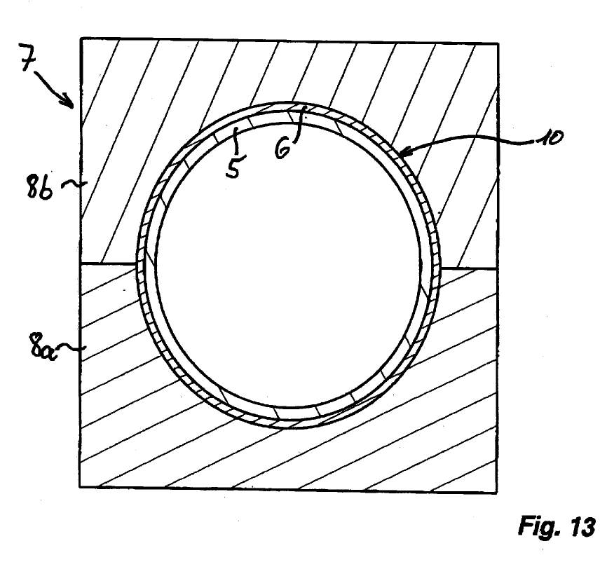

FIGS. 11 through 13 show the procedural steps for a production technique that is modified with respect to the procedure prescribed in FIGS. 1 through 10. This procedural sequence begins unchanged, as described in the context of FIGS. 1 through 5. In the modified procedure, the manufactured part's inner core (3) is now removed after coating the inner layer sheathing (5) with fiber-reinforced material (6) and before introducing the workpiece into the prefabricated form (7): FIG. 11. This is possible, since the fiber-reinforced material (6) gives the workpiece a basic solidity that makes handling the workpiece possible even without the manufactured part's inner core (3) without further deforming the workpiece. The cored workpiece is introduced into the prefabricated form (7) (FIG. 12), and the inner layer sheathing (5) is expanded, e.g., preferably by pressure impact: FIG. 13. After the fiber-reinforced material (6) is cured, the manufactured part (10) is taken out of he prefabricated form (7), which corresponds to the representation according to FIG. 9. In accordance with FIG. 10, here, too, the expanded inner layer sheathing (5) can be removed.

If a manufactured part (10) is to be produced with a completely closed surface, then expanding the inner layer sheathing (5) by introducing gas or liquid is not possible since the inner layer sheathing (5) is completely enclosed with fiber-reinforced material and, consequently, no access to a source of pressure is possible.

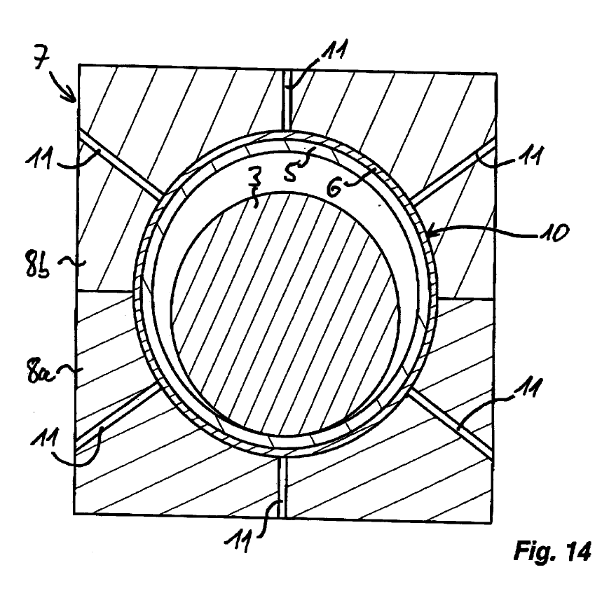

In order, nevertheless, to be able to press the fiber-reinforced material (6) onto the interior wall of the prefabricated form (7) under pressure, a negative pressure can be generated on the prefabricated form (7): FIG. 14. For this, several opening channels are provided in the two prefabricated form halves (8a and 8b) of the prefabricated form (7) through which air can be sucked into the interior cavity of the prefabricated form (7). Since the inner layer sheathing is (5) air tight, the air contained in it cannot escape so that the inner layer sheathing (5) expands through the surrounding negative pressure and the fiber-reinforced material (6) is pressed onto the interior wall of the prefabricated form (7). In this way, to be sure, only a comparatively slight, though nevertheless sufficient, pressure is removable. Alternatively, they could be used under a high pressure atmosphere and universalized in order to reach higher pressures.

Since a manufactured part (10) produced in this way shows no opening leading to the outside, the manufactured part's inner core (3) remains in the finished manufactured part (10).

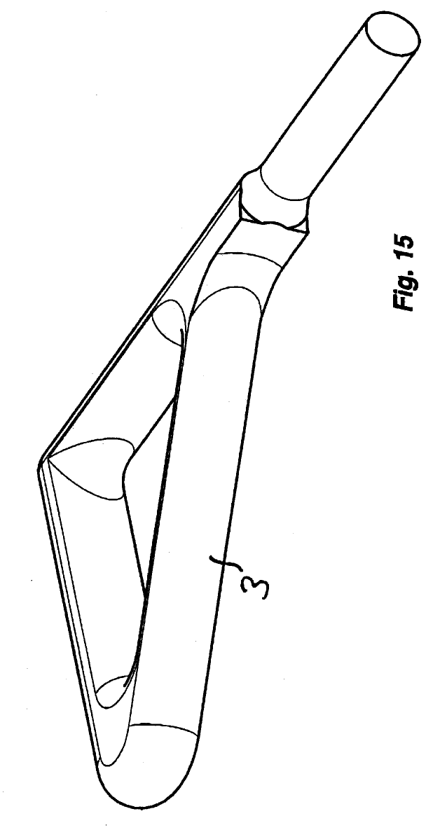

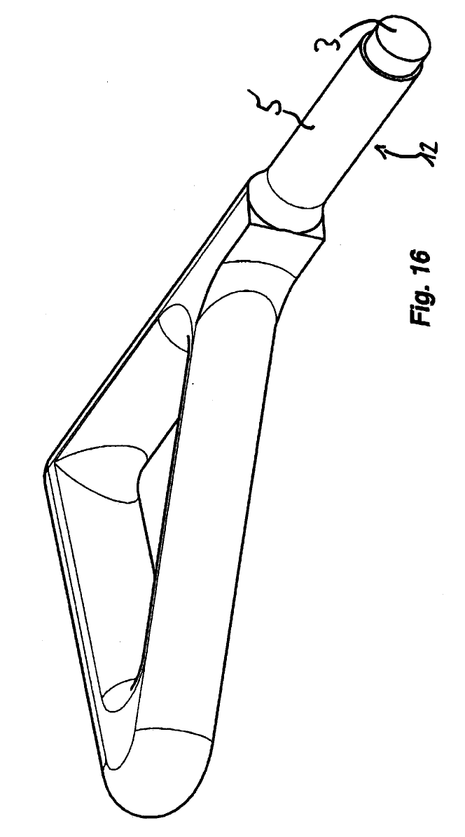

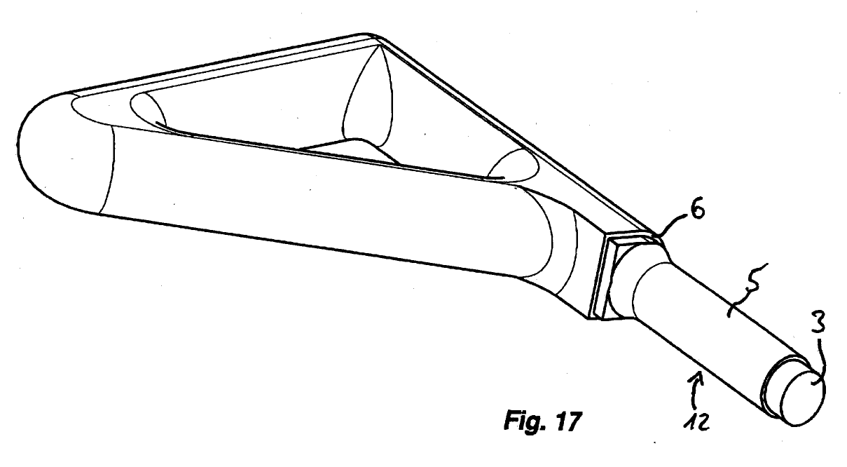

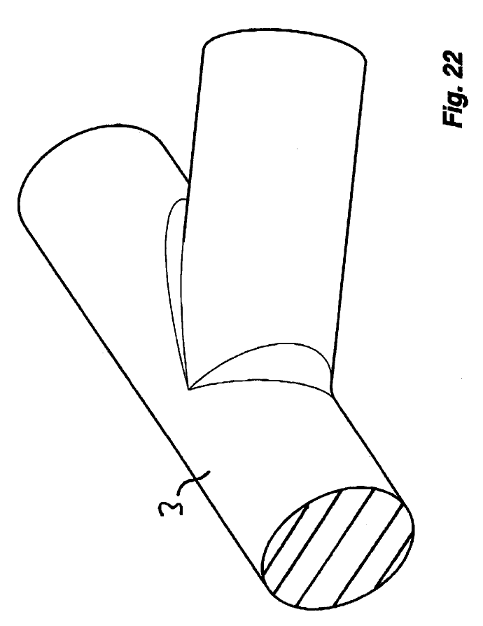

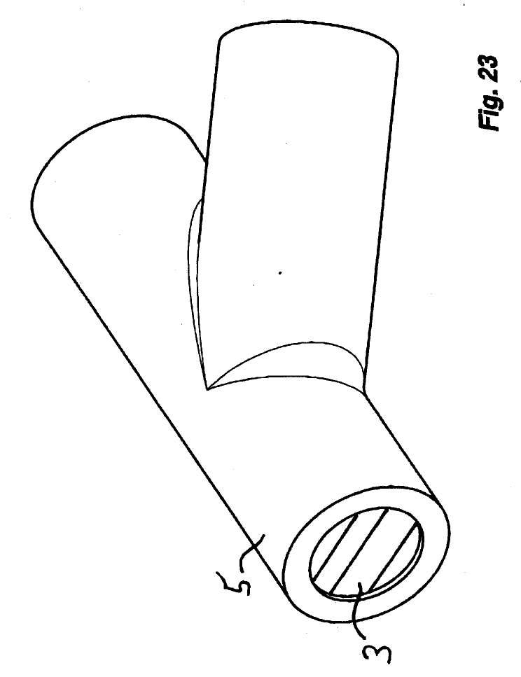

FIGS. 15 through 21, as well as 22 through 28, describe the procedural sequence on the basis of perspective representations. The manufactured part's inner core (3) is displayed in FIGS. 5 and 22, which, according to FIGS. 16 and 23, is coated with an inner layer sheathing (5) of flexible material. In accordance with FIGS. 17, 24 and 25, the inner layer sheathing (5) is coated with fiber-reinforced material (6).

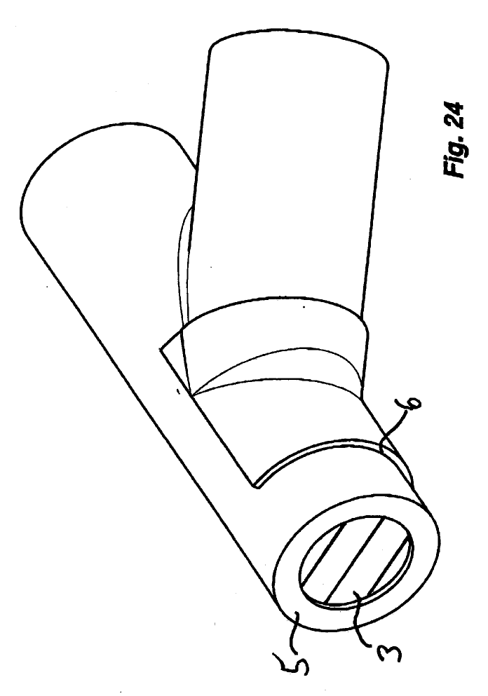

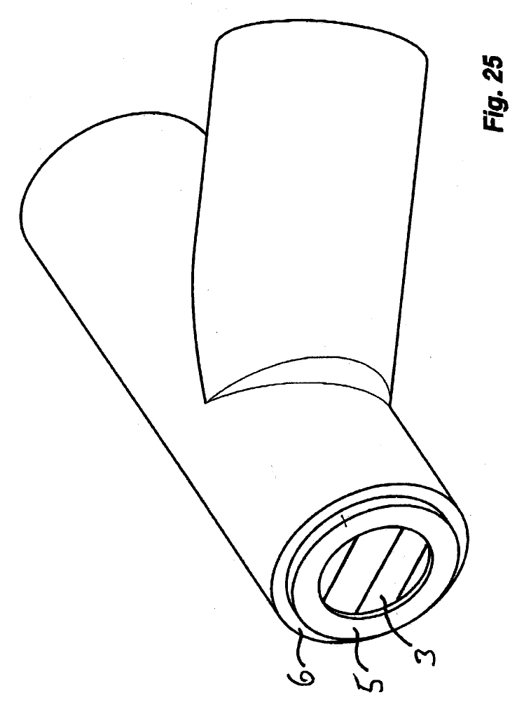

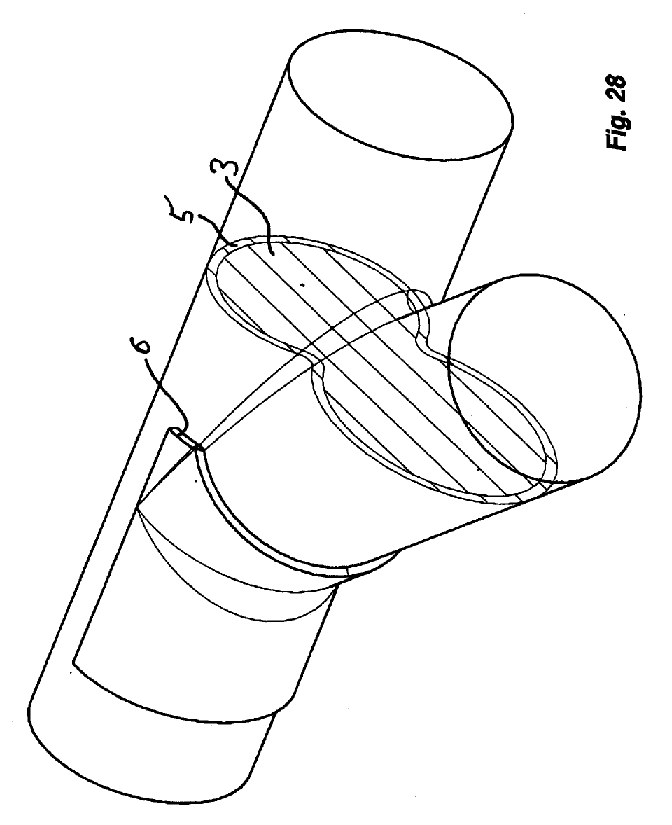

The true to form attachment of an initial layer of fiber is thereby represented in FIG. 24, and then in FIG. 25 the entire workpiece is coated with fiber-reinforced material (6). FIG. 28 shows the workpiece in accordance with FIG. 24 in another perspective that is partially cropped. From this representation, the layered construction of the workpieces from the manufactured part's inner core (3), the inner layer sheathing (5) and the fiber-reinforced material (6) become clear.

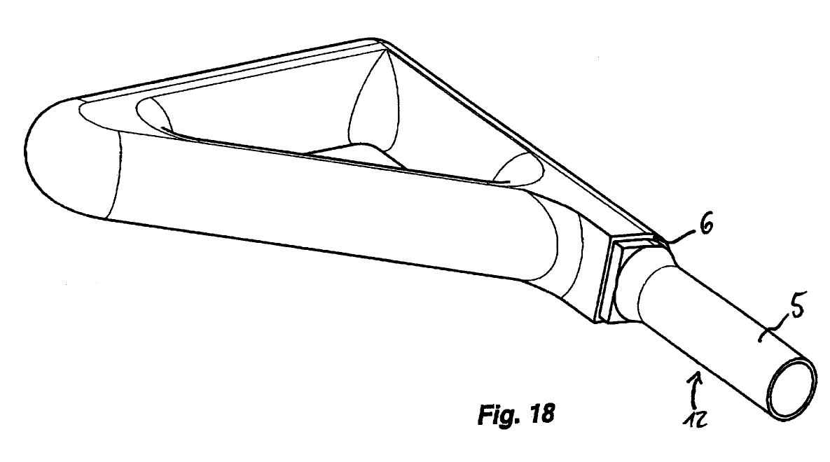

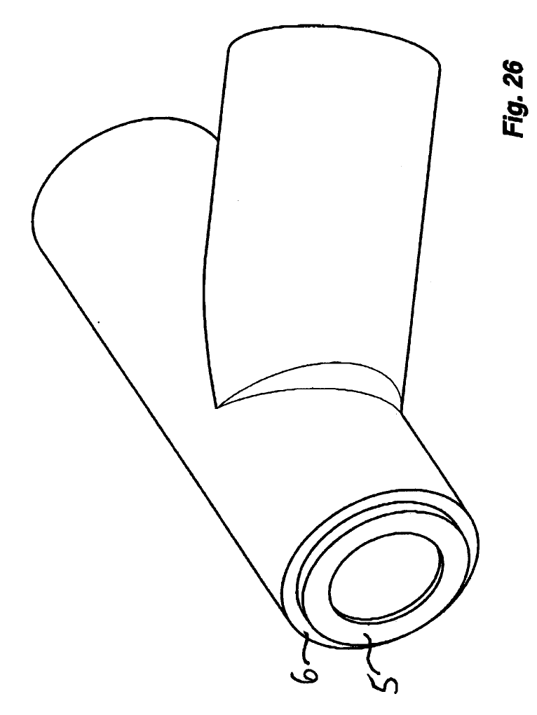

FIGS. 18 and 26 show the thereby finalized workpiece from which the manufactured part's inner core (3) was removed. This workpiece is to be introduced into the prefabricated form (7), the inner layer sheathing (5) is to be expanded via connection to a source for pressurized gas or liquid on the connecting end (12) (FIG. 18) and the fiber-reinforced material (6) is to be pressed onto the inner wall of the prefabricated form (7).

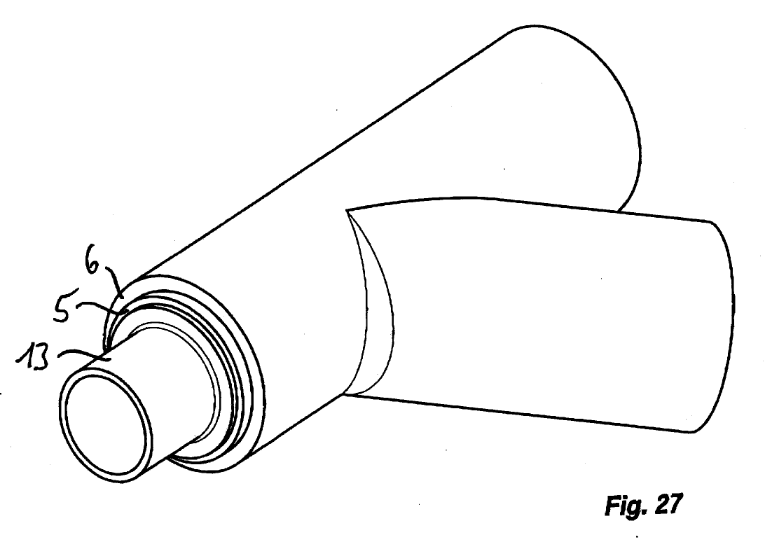

FIG. 27 shows a particular procedural step in which a separate connecting piece (13) is installed on the inner layer sheathing (5) for a source for pressurized gas or liquid. The separate connecting piece (13) and the inner layer sheathing (5) are preferably of the same material and can be connected by adhesion, welding, fusing or similar connective procedures.

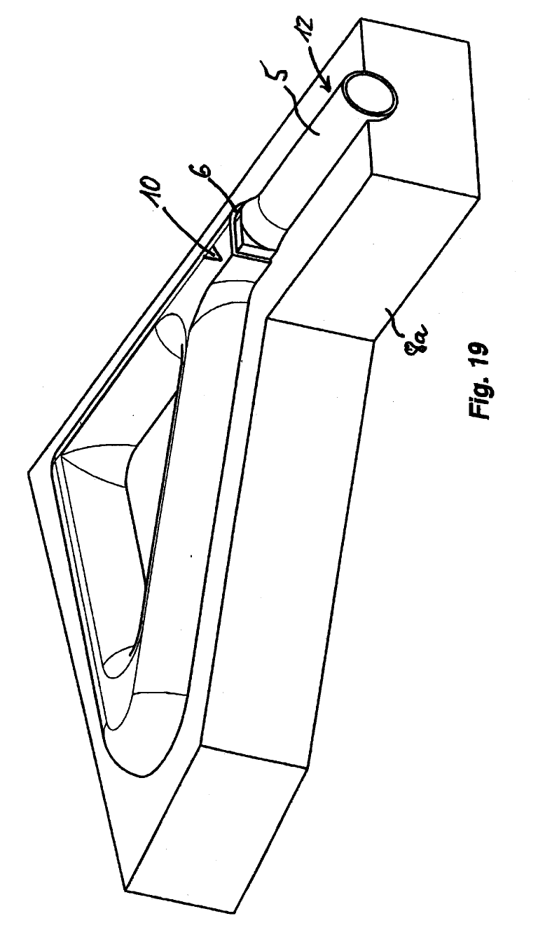

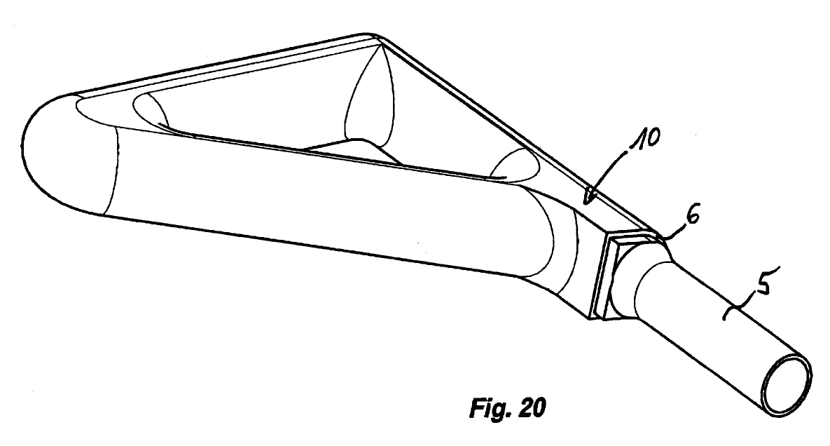

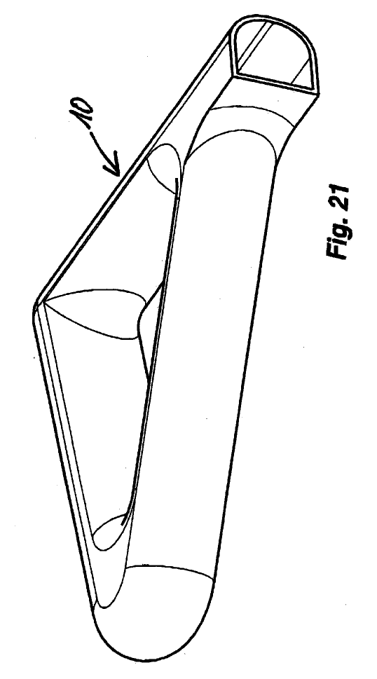

FIG. 19 shows the opened prefabricated form in which, for a better overview, only one of the two prefabricated form halves (8a) is displayed after the fiber-reinforced material (6) has cured. The manufactured part (10) that is produced in this way is removed from the prefabricated form (7) (FIG. 20) and then, in conclusion, the flexible inner layer sheathing (5) (FIG. 21) is removed.

One embodiment of the present invention provides a procedure for producing a fiber-reinforced manufactured part (10), a manufactured part's interior component (3) that is at least largely adjusted to the forming process of the manufactured part (10) that is to be produced is coated with flexible material for the construction of an least largely air and water tight inner layer sheathing (5) for the interior manufactured part. The inner layer sheathing (5) is to be covered with fiber-reinforced material (6), the inner layer sheathing (5) with the fiber-reinforced material (6) is to be introduced into a prefabricated form (7), the inner layer sheathing (5) for the formation of the fiber-reinforced material (6) is to be expanded to the manufactured part (10) that is to be produced and the fiber-reinforced material (6) is thereby to be pressed under pressure impact for curing onto the interior wall of the prefabricated form (7) that functions as a female form (FIG. 6).

I claim:

1. A method for producing a fiber-reinforced manufactured part comprising positioning a fiber laminate onto an expandable inner core; the inner core is coated with the fiber laminate and is positioned in a prefabricated mold; expanding the inner core so that the inner core is generally shaped to form the manufactured part during the molding process, wherein the inner core is coated with a flexible material adapted to form a substantially air and water tight inner layer sheathing on an interior surface of the manufactured part, the inner layer sheathing being covered with a fiber-reinforced material, the inner layer sheathing with the fiber-reinforced material covering is positioned into the prefabricated mold, during the molding process pressure is used between the interior core and the inner layer sheathing to cause expansion of the inner layer sheathing that causes the fiber-reinforced material to be expanded to form the manufactured part and to press the fiber-reinforced material against an interior wall of the prefabricated mold using pressure during the curing.

2. The method according to claim 1, further comprising at least one of a metal part and an already cured fiber-reinforced part are introduced into the prefabricated form which are then solidly interconnected with the manufactured part to further strengthen the manufactured part after the fiber-reinforced material has cured.

3. The method according to claim 1, further comprising that after the fiber-reinforced material has cured, the manufactured part is taken out of the prefabricated mold.

4. The method according to claim 1, further comprising that the inner layer sheathing is expanded by a gas or liquid supply in an interior cavity of the inner layer sheathing.

5. The method according to claim 1, further comprising that the inner layer sheathing is expanded by production of a negative pressure on the prefabricated form.

6. The method according to claim 1, further comprising that the manufactured part's inner core is removed from the inner layer sheathing before the inner layer sheathing that is equipped with fiber-reinforced material is positioned into the prefabricated form.

7. The method according to claim 1, further comprising that, after the curing and removal of the manufactured part from the prefabricated form, at least the manufactured part's inner core is at least partially removed from the manufactured part.

8. The method according to claim 7, further comprising at least partially removing the inner layer sheathing from the manufactured part.

9. The method according to claim 1, further comprising that the prefabricated form is to be at least partially heated during the impact of pressure on the inner layer sheathing.

10. The method according to claim 1, further comprising that the inner core used to form the at least partially largely air and water tight inner layer sheathing is at least one of immersed in liquid material, sprayed, painted, and impacted with the flexible material, the flexible material being attached to the inner core so that it flexibly hardens after the immersion or similar impact process.

11. The method according to claim 1, further comprising that a connecting piece is to be installed on the inner layer sheathing for a source of pressurized gas or liquid.

12. The method according to claim 1, wherein the step of coating the inner layer sheathing with the fiber-reinforced material comprises positioning fiber material on the inner layer sheathing and then soaking the combination with resin.

13. The method according to claim 1, wherein the coating of the inner layer sheathing with fiber-reinforced material comprises providing fiber material that is soaked in resin and is then positioned on the inner layer sheathing.

14. The method according to claim 1, further comprising the production of the inner core comprises filling a core form with malleable core material, taking the inner core out of the core form after the core materials have cured.

15. The method according to claim 1, further comprising the inner core being formed of a plurality of partial inner cores.

16. The method according to claim 1, wherein the inner core is formed by a foamed material.

17. The method according to claim 1, wherein the inner core is formed by a Polystyrol material.

18. The method according to claim 1, wherein the inner core is formed by an EPS material.
